(19) United States
(12) Patent Application Publication
(10) Pub. No.: US 2026/0126309 A1
(43) Pub. Date: May 7, 2026

(54) INSULATED WIRELESS DATA LOGGER SHUTTLE FOR BLAST FREEZING AND LYOPHILIZATION

(71) Applicant: Merck Sharp & Dohme LLC, Rahway, NJ (US)

(72) Inventors: John P. Murphy, Horsham, PA (US); Nicholas Roscioli, Phoenixville, PA (US); Derrick M. Smith, Newtown Square, PA (US)

(73) Assignee: Merck Sharp & Dohme LLC, Rahway, NJ (US)

(21) Appl. No.: 19/371,198

(22) Filed: Oct. 28, 2025

Related U.S. Application Data
(60) Provisional application No. 63/715,205, filed on Nov. 1, 2024.

(51) Int. Cl. G01D 11/24; G01K 1/08

(52) U.S. Cl. CPC G01D 11/245; G01K 1/08

(57) ABSTRACT

A shuttle includes an upper housing having a top surface, a thickness and a semi-cylindrical upper cavity, the upper housing having a perimeter that includes a plurality of upper concavities, and a lower housing having a bottom surface, a thickness and a semi-cylindrical lower cavity, the lower housing having a perimeter that includes a plurality of lower concavities, wherein the upper concavities and the lower concavities are aligned with one another, wherein the lower housing and the upper housing comprise an insulating porous structure.

### CROSS-REFERENCE TO RELATED APPLICATIONS

The application claims benefit of priority to U.S. Provisional Application No. 63/715,205, filed November 1, 2024, the contents of which are incorporated herein by reference in its entirety.

### FIELD OF THE INVENTION

The present disclosure relates generally to data loggers. More specifically, the present disclosure relates to containers, known as shuttles, for protecting data loggers during a manufacturing process.

### BACKGROUND OF THE INVENTION

Liquid nitrogen blast freezing is a process used to rapidly freeze products, such as pharmaceuticals, food items, or other goods by exposing them to extremely low temperatures. Liquid nitrogen has a boiling point of -196°C (-321°F), making it highly effective for quick freezing. In a typical liquid nitrogen blast freezing, a product is first prepared and placed on a conveyor belt, often in several trays. The product is then exposed to liquid nitrogen via a spraying process, an immersion, a liquid nitrogen vapor bath or other technique. The extreme cold causes the water in the product to freeze almost instantly, forming very small ice crystals. This rapid freezing helps preserve the inherent characteristics of the product. Once frozen, the products are usually transferred to cold storage at a temperature that maintains their frozen state.

Blast freezing is much faster than traditional freezing methods, and can help maintain the quality of the product by preventing large ice crystals, which can damage cell structures. Specifically, blast freezing effectively preserves the cellular structures of samples at optimum levels by minimizing the formation of ice crystals that can negatively impact the viability of cell membranes. The extremely low temperatures inhibit the growth of bacteria and other pathogens. Blast freezing may also be used as part of a lyophilization process in pharmaceutical products. In the lyophilization process, a drug product may be frozen using blast freezing or the like, and may be followed by establishing a vacuum and drying the drug product under vacuum at a low temperature, which results in a freeze-dried cake that can be reconstituted using sterile diluents. By way of example, a biologic or drug product may be dissolved in an appropriate solvent, typically water for injectable material. The bulk solution may be sterilized, for example, through a 0.22-micron bacteria-retentive filter, and the solution may then be placed in individual sterile containers, typically glass vials, which are then partially stoppered under aseptic conditions. These partially stoppered vials are transported to the lyophilizer and loaded under aseptic conditions. The solution is then frozen within the freeze-drying chamber and vacuum is applied to the chamber. Using heat, the water is sublimed from the frozen state. The vials are then completely stoppered, typically using a hydraulic or screw rod stoppering mechanism. It would be beneficial to accurately measure, log and record product temperature data as it undergoes a blast freezing and/or a lyophilization process.

### SUMMARY OF THE INVENTION

In some examples, a shuttle includes an upper housing having a top surface, a thickness and a semi-cylindrical upper cavity, the upper housing having a perimeter that includes a plurality of upper concavities, and a lower housing having a bottom surface, a thickness and a semi-cylindrical lower cavity, the lower housing having a perimeter that includes a plurality of lower concavities, wherein the upper concavities and the lower concavities are aligned with one another, wherein the lower housing and the upper housing comprise an insulating porous structure.

In some examples, a system includes a shuttle having an upper housing having a top surface, a thickness and a semi-cylindrical upper cavity, the upper housing having a perimeter that includes a plurality of upper concavities, and a lower housing having a bottom surface, a thickness and a semi-cylindrical lower cavity, the lower housing having a perimeter that includes a plurality of lower concavities, the lower housing and the upper housing comprise an insulating porous structure, wherein the upper concavities and the lower concavities are aligned with one another, and a data collector disposed within the shuttle, the data collector having a main unit and a sensor wire.

### BRIEF DESCRIPTION OF THE DRAWINGS

Various embodiments of the presently disclosed shuttles are disclosed herein with reference to the drawings, wherein:

FIG. 1 is a schematic illustration of a data collector.

FIGS. 2A-2C illustrate a system including a vial, a data collector and a shuttle according to one embodiment of the disclosure.

FIGS. 2D-2E are schematic cross-sectional illustrations showing possible examples of the interior of the porous structure for the upper and lower housings.

FIGS. 3A-3D illustrate shuttles being disposed in a tray of vials, according to one embodiment of the disclosure.

FIGS. 4A-4F illustrate a shuttle variation according to another embodiment of the disclosure.

Various embodiments are described below with reference to the appended drawings. It is to be appreciated that these drawings depict only some embodiments of the disclosure and are therefore not to be considered limiting of its scope.

### DETAILED DESCRIPTION OF THE INVENTION

Despite the various improvements that have been made to data loggers, conventional methods suffer from some shortcomings as discussed above. As defined herein, the terms “lyophilization,” “lyophilized,” and “freeze-dried” refer to a process by which the material to be dried is first frozen and then the ice or frozen solvent is removed by sublimation in a vacuum environment. An excipient may be included in pre-lyophilized formulations to enhance stability of the lyophilized product upon storage. Moreover, a “reconstituted” formulation is one that has been prepared by dissolving dried vaccine formulation in a diluent such that the vaccine is dispersed in the reconstituted formulation. The reconstituted formulation is suitable for administration, (e.g., intramuscular administration), and may optionally be suitable for subcutaneous administration.

Data loggers or data collectors are used for documenting lyophilization processes and checking lyophilization chambers, for example in the production of pharmaceutical products, where it is of particular importance that the lyophilization process is controlled precisely. The product containers are usually open vials made of glass or polymer. Each vial has a stopper at the opening. During the lyophilization process, the stopper is only partially put into the vial opening, and the cap's holes enable vapor to escape. When the lyophilization process is complete, the stopper is placed into the vial, isolating the dried product from the environment. The stoppers of all vials on a support surface are normally forced down at the same time using a plate-shaped element, which could be another superjacent support surface.

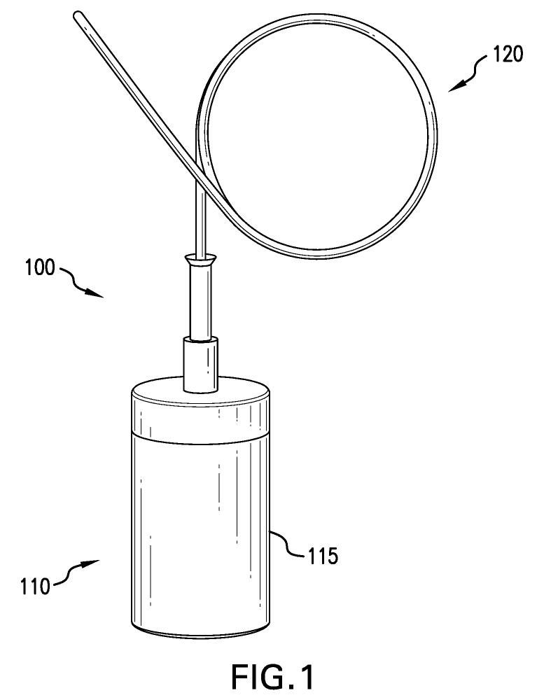

As shown in FIG. 1, a wireless data logger or data collector 100 may be used for continuous measurement of product temperature (and other variables) during liquid nitrogen blast freezing and/or subsequent lyophilization. Data collector 100 may generally include a main unit 110 having a cylindrical stainless-steel body 115 and a semi-flexible sensor wire 120 (often referred to as a “sensor”, “temperature wire” or “temperature probe”). Sensor 120 is configured to be placed within one of the vials. Main unit 110 may house a battery, an electronics unit connected to sensor wire 120 via the connection terminal and/or wires. The electronics unit is responsible for receiving data from sensor wire 120, which will be placed adjacent or within a test product container. The collected data may then be made available for use in a data processing unit. For this purpose, the electronics unit may for example include a wireless transmission receiver unit, a data storage unit, a hall sensor, and a control unit. Data collector 100 may monitor, collect and/or store one or more variables including, but not limited to, temperature, pressure, conductivity, relative humidity, vacuum and steam penetration. In one embodiment, the data collector 100 is a TRACKSENSE® Pro X Wireless Data Logger with Semi Flexible Temperature Sensor available from ELLAB A/S.

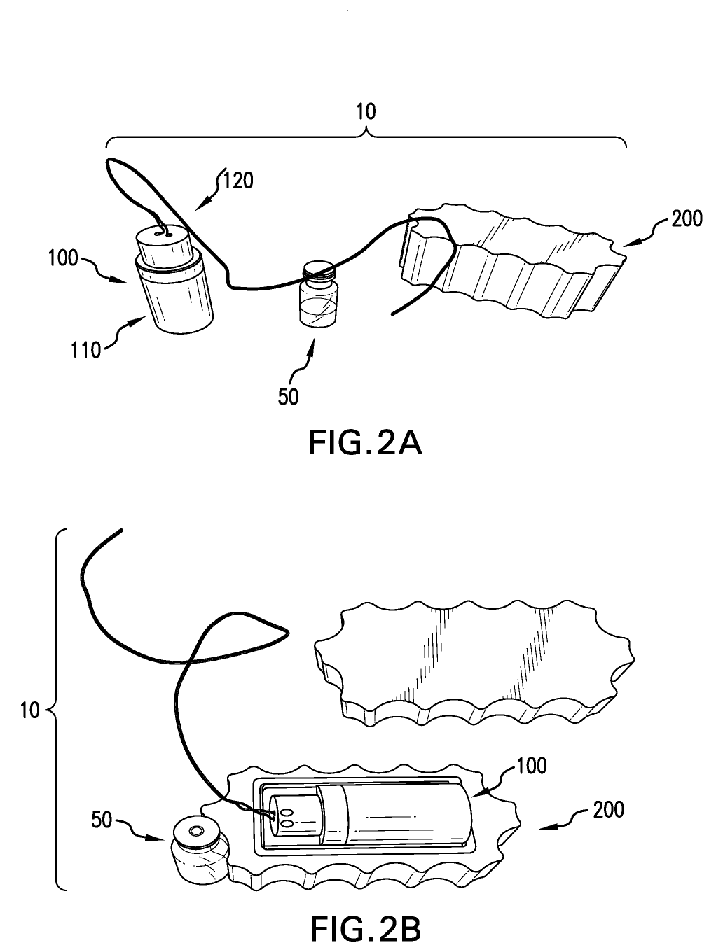

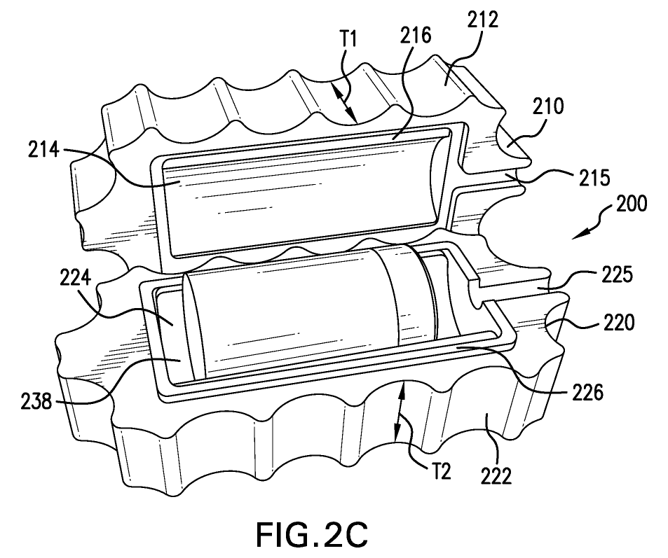

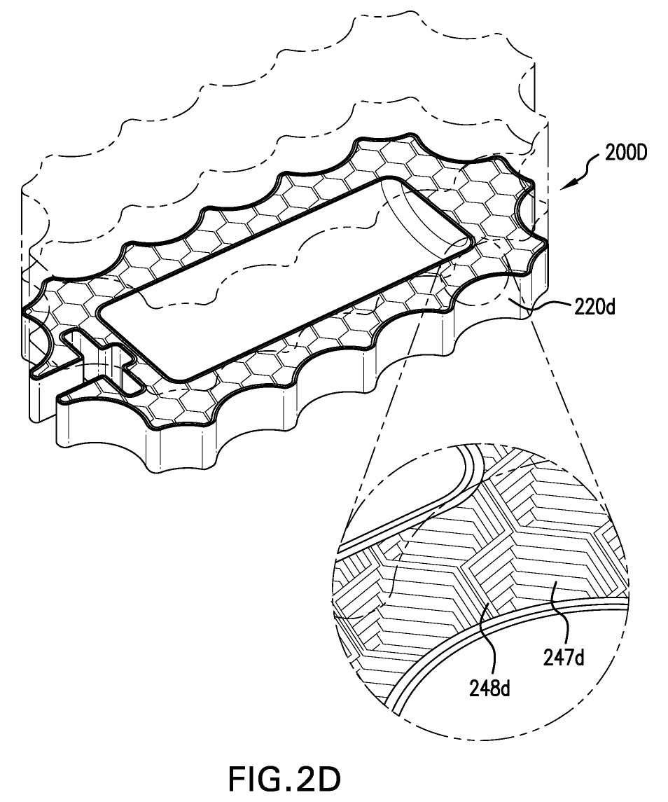

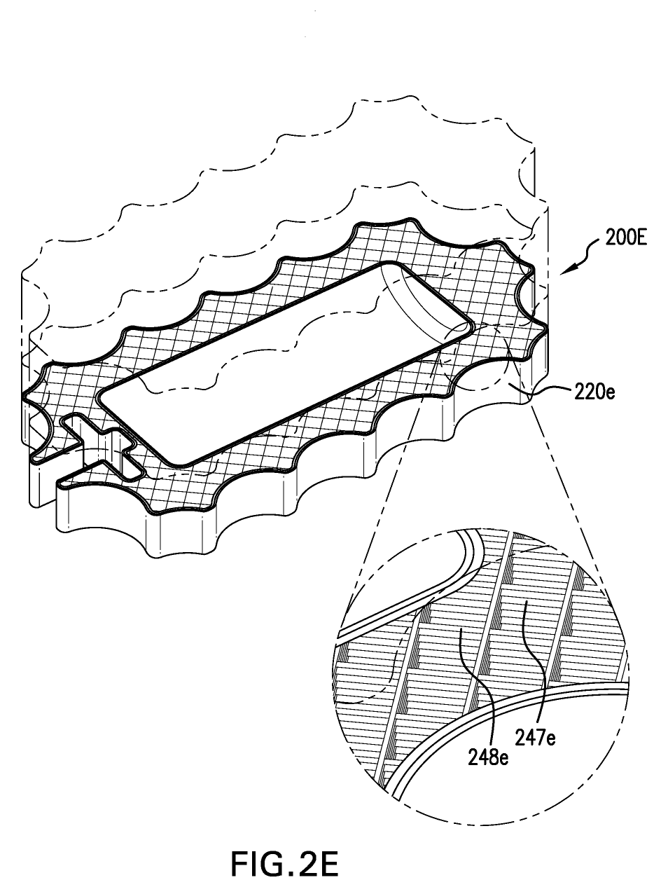

FIGS. 2A-2C illustrate the components for a system 10 for logging data during a manufacturing process (e.g., blast freezing and/or lyophilization), which includes a vial 50 containing a drug product, a data collector 100 and a shuttle 200. Shuttle 200 may receive a portion of data collector 100 and may be used to protect the battery pack and data logger from the extreme low temperatures (-120 C) associated with blast freezing while simultaneously riding along with the vials without disrupting the vial pack formation. FIGS. 2B-2C show the shuttle 200 in an open condition, with the data collector 100 being disposed therein. As best shown in FIG. 2C, shuttle 200 may include an upper housing 210 and a lower housing 220. Upper and lower housings 210,220 may be formed of a porous support structure capable of insulating the electronics and battery of data collector 100 from the manufacturing process. In some examples, the porous support structure of upper and/or lower housings 210,220 may comprise a polymer or thermoplastic (e.g., polylactic acid (PLA)). In some examples, the porous structure may be chosen based on suitable temperature stress or cycling. As used herein, when used to refer to a structure, the term “porous” may refer to a construction made of a material having natural or engineered, regular or dead spaces, define within its volume. Alternatively, the term “porous” may refer to a material itself so that the substance that makes up the structure has natural pores or voids.

In some examples, each of upper and lower housings 210,220 may be formed of a porous structure capable of forming an internal construction or scaffold having regular or irregular dead space(s). By way of example, FIGS. 2D-2E show cross-sectional views of two such shuttles. In FIG. 2D, shuttle 200D includes a lower housing 220d formed of a porous structure with a cross-sectional shape that reveals a number of regularly-arranged honeycomb-shaped cells 247d separated from one another by material 248d. Each of the cells 247d may be closed or distinct from other(s) (e.g., there is no fluid communication between adjacent cells or other cells). Alternatively, an open cell configuration may be used where some or all cell(s) 247d may be in communication with certain other cells, or all other cells of the structure. Though only the lower housing is shown, it will be understood that the upper housing may include similar configurations of porous structures. The structure may include repeating patterns of shapes (e.g., repeating patterns of polygons, gyroids, or other regular-shapes). The structure may also include irregular cells randomly dispersed throughout the volume of the structure.

Porosity is a dimensionless value, typically expressed as a percentage, used to measure the proportion of empty space within a sample compared to its total volume. Relatedly, a solid fraction can be calculated, which is generally (100-porosity)/100. Thus, as used herein, a porosity of 20% would correspond to a solid fraction of 80%. In some examples, the solid fraction of the structure that forms the lower housing 220d and the upper housing may be between 5% and 50%, between 10% and 40%, or between 20% and 30%, with dead space being defined where the material is not present (e.g., within each cell). Stated another way, the porosity of the structure may be between 95% and 50%, between 90% and 60% or between 80% and 70% with a large percentage of the overall volume being dead space. When the data collector 100 is disposed within the cylindrical cavity, the dead air space of the porous structure may insulate the data collector from blast freezing temperatures. FIG. 2E illustrates a similar shuttle 200E with a lower housing 220e that includes a porous structure with a basket-weave configuration that forms a number of regularly-arranged rectilinear-shaped cells 247e separated from one another by material 248e. Again, each of the cells 247e may be closed or distinct from other(s) (e.g., there is no fluid communication between adjacent cells or other cells). Alternatively, an open cell configuration may be used where some or all cell(s) 247e may be in communication with certain other cells, or all other cells of the structure. Though only the lower housing is shown, it will be understood that the upper housing may include similar configurations of porous structures. In some examples, the solid fraction of the structure that forms lower housing 220d and the upper housing may be between 5% and 50%, between 10% and 40%, or between 20% and 30%, with dead space being defined where the material is not present (e.g., within each cell).

Generally, shuttle 200 may be constructed of two generally symmetric pieces (e.g., upper and lower housings 210,220) capable of easy assembly and disassembly for installation and retrieval of the data collector 100. Shuttle 200 may have external dimensions with a total area equal to approximately 16 hexagonally packed 2R vials so that it can be inserted into a tray of hexagonally packed 2R vials without disrupting vial spacing. Additionally, shuttle 200 may have a total height of approximately 35 mm or less to allow for stopper compression during stoppering in the lyophilizer. The disclosed dimensions of the shuttle and the types, sizes and/or dimensions of the vials are only exemplary and may be varied as needed.

Upper housing 210 may be generally rectangular with a repeating set of concavities 212 on its outer perimeter. Each concavity 212 may have a radius of curvature of between 16 mm and 17 mm (e.g., between 16.05 mm and 16.25 mm). In some examples, the radius of curvature of each concavity 212 corresponds to a curvature of a vial so that the shuttle may be nestled between groupings of vials. Upper housing 210 may have a flat upper surface (not shown in FIG. 2C), a semi-cylindrical inner cavity 214 opposite the upper surface and an inner chamfer 216 surrounding inner cavity 214. An upper lateral channel 215 may be provided on one edge of the upper housing 210 for passing a temperature sensor wire of a data collector. Upper housing 210 may have a thickness T1 that is approximately half of the diameter of data collector 100 (e.g., between 17 mm and 18 mm).

Lower housing 220 may be generally rectangular with a repeating set of concavities 222 on its outer perimeter. Concavities 222 may have the same radius of curvature as concavities 212. Concavities 222 may also be aligned with concavities 212 so that each concavity on the upper housing corresponds, and aligns, with a concavity on the lower housing. In some examples, the radius of curvature of each concavity 222 corresponds to a curvature of a vial so that the shuttle may be nestled between groupings of vials. Lower housing 210 may have a flat bottom surface (not shown in FIG. 2C), a semi-cylindrical inner cavity 224 opposite the upper surface and an inner rib 226 surrounding inner cavity 214. A lower lateral channel 225 may be provided on one edge of the lower housing 220 for passing a temperature sensor wire of a data collector. In some examples, lower lateral channel 225 may be aligned with upper lateral channel 215 and configured to define a larger combined lateral channel. Lower housing 220 may have a thickness T2 that is approximately half of the diameter of data collector 100 (e.g., between 17 mm and 20 mm).

Upper housing 210 and lower housing 220 may be generally symmetric and similar in shape, and when joined together inner cavities 214,224 may define a combined cylindrical cavity capable of accommodating a data collector 100. In at least some examples, the combined cylindrical cavity is approximately 25 mm in diameter and 60 mm in length. Other shapes and sizes are possible. In some examples, the interior surface of the combined cylindrical cavity may be covered or lined with another material (e.g., silicone matt 238) that is smooth to facilitate cleaning. To keep the two components together, inner rib 226 may be releasably friction-fit or press-fit within inner chamfer 216. As shown, inner cavities 214,224 collectively define a cylindrical cavity or space that is equal to or slightly larger than data collector 100 to accommodate data collectors of different sizes. Although inner housing 210 and lower housing 220 are shown as being separate or separable components, it will be understood that the two components may be joined together via a hinge along one of the edges so that the inner cavities are accessible, but that the two components can be closed when needed.

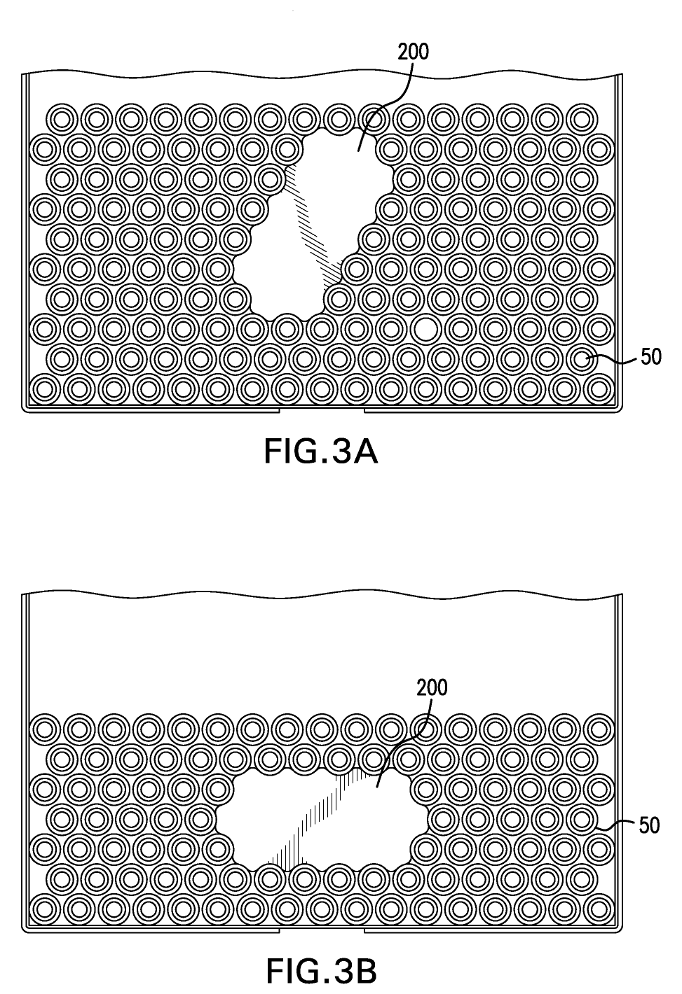

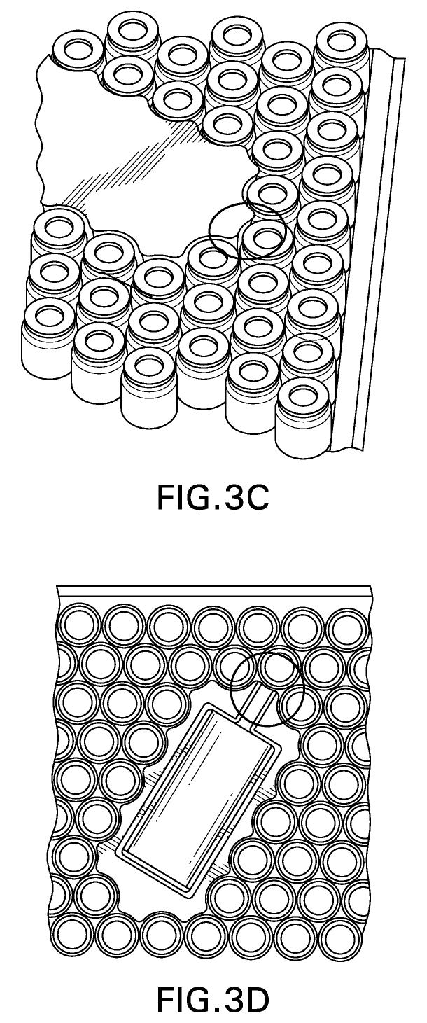

FIGS. 3A-3D show a shuttle 200 in the closed condition being disposed in a tray between a series of vials 50. As shown, the upper and lower housings 210,220 are brought together and secured with one another with data collector 100 being disposed therein. Shuttle 200 may be placed in two positions with respect to the rows of vials 50 without disturbing the placement, and the concavities of shuttle 200 may accommodate the vials so that the vials surround and abut the shuttle. FIG. 3C-3D shows the channels 215,225 disposed on one side of the shuttle 200 where the temperature sensor wire of the data collector exits from the interior of the shuttle 200 to the vial(s). It will be understood that variations are possible and that at least one of channels 215,225 may be disposed and exit out of any of the six sides of shuttle 200.

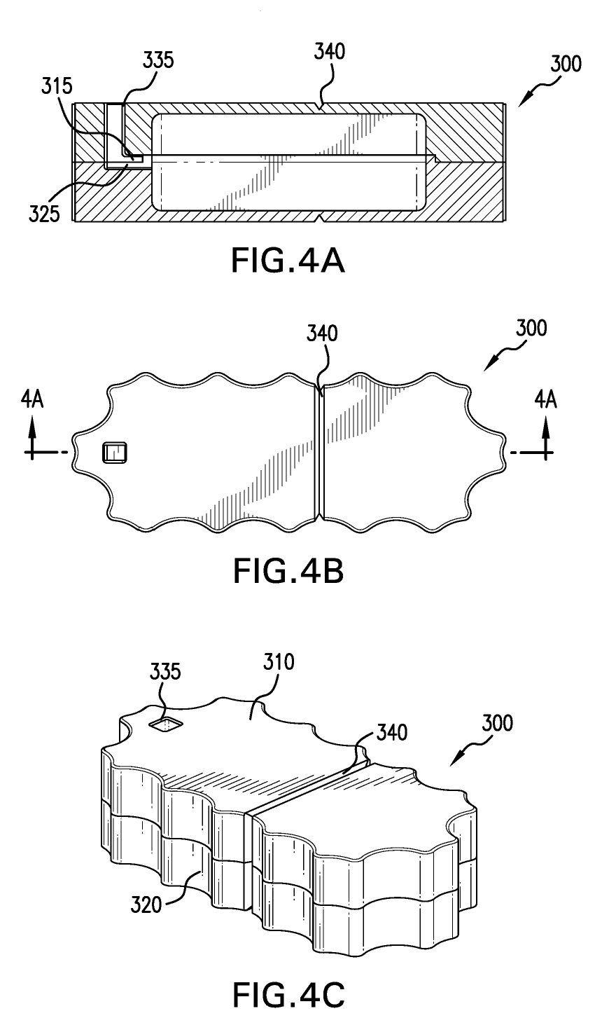

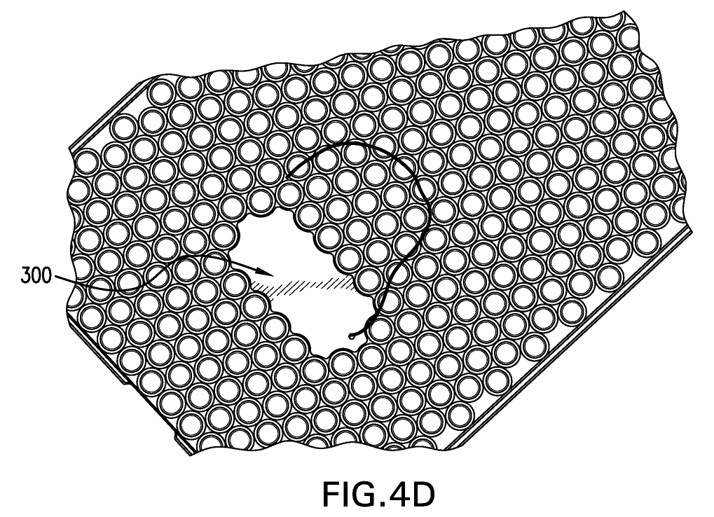

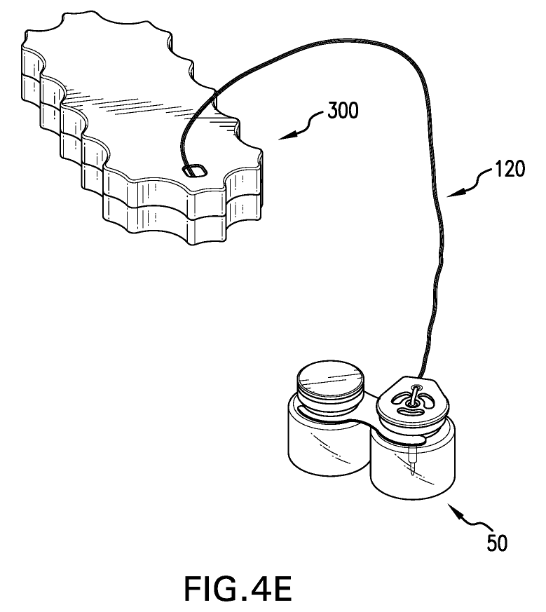

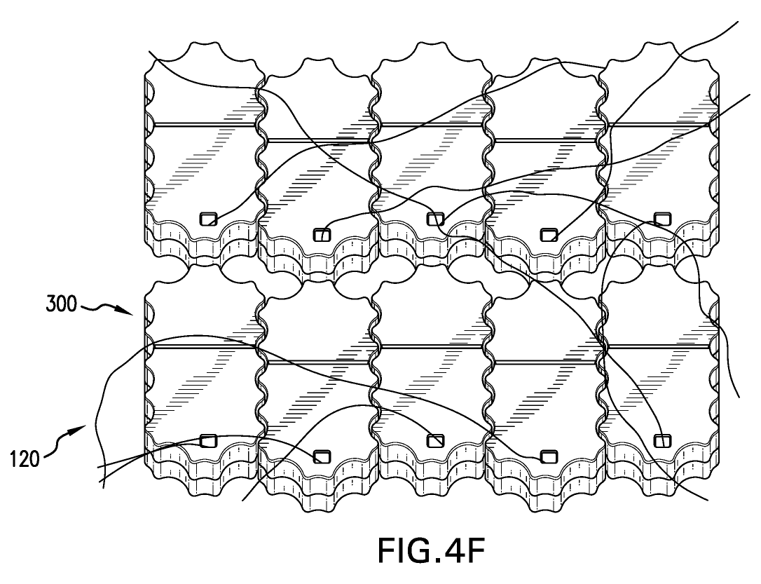

In one variation, shown in FIGS. 4A-4D, a shuttle 300 includes an upper housing 310 and a lower housing 320. Each of upper housing 310 and lower housing 320 may include features as previously discussed (e.g., inner cavities, concavities on the perimeter, inner chamfers and inner ribs, etc.). Notably, shuttle 300 includes an L-shaped channel whereby channels 315,325 in the upper and/or lower housing extend laterally, and then join a perpendicular channel 335 in the upper housing so that a temperature sensor wire exits through the upper housing (See, FIG. 4D). In at least some examples, the perpendicular channel is 1.5 mm in diameter and capable of receiving a routing duplex 30 g thermocouple sensor wire. Shuttle 300 may also include a continuous thin groove 340 extending along the top surface of the upper housing 310, the side surfaces of the upper housing 310, the bottom surface of the lower housing 320 and/or the side surface of the lower housing 330. Thin groove 340 may be dimensioned to accept a rubber band or other closure means to secure the upper and the lower housings together. FIG. 4E illustrates the closed shuttle 300 with the thermocouple sensor wire 120 extending from the top surface of the upper housing and being placed in a vial to collect data. FIG. 4F illustrates that multiple shuttles can be disposed next to one another, and that due to the recurring shape on the outer perimeter, multiple shuttles may be nested with others if data is to be collected from multiple vials via multiple data collectors.

In use, vials 50 along with the shuttle 200,300 containing the battery pack and data logger may be loaded into the lyophilizer where the data collector 100 continues to measure and record the product temperature during loading, lyophilization, and/or unloading. The shape and size of the shuttles may allow them to be used within the existing workflow without displacing too many vials and without impeding other functions (e.g., stoppering, etc.).

It is to be understood that the embodiments described herein are merely illustrative of the principles and applications of the present disclosure. Moreover, certain components or steps of a method of using the device are optional, and the disclosure contemplates various configurations and combinations of the steps disclosed herein. Additionally, as used herein, the term “couplable” refers to two or more components that cooperate, join or engage one another. It will be understood that where two or more components are said to be “coupled” or “couplable” that they may also be unitarily or integrally formed. It is therefore to be understood that numerous modifications may be made to the illustrative embodiments and that other arrangements may be devised without departing from the spirit and scope of the present disclosure as defined by the appended claims.

It will be appreciated that the various dependent claims and the features set forth therein can be combined in different ways than presented in the initial claims. It will also be appreciated that the features described in connection with individual embodiments may be shared with others of the described embodiments.

1. A shuttle, comprising:
an upper housing having a top surface, a thickness and a semi-cylindrical upper cavity, the upper housing having a perimeter that includes a plurality of upper concavities; and
a lower housing releasably couplable to the upper housing and having a bottom surface, a thickness and a semi-cylindrical lower cavity, the lower housing having a perimeter that includes a plurality of lower concavities configured to be aligned with the plurality of upper concavities,
wherein the lower housing and the upper housing comprise an insulating porous structure.

2. The shuttle of claim 1, wherein each of the upper concavities and the lower concavities has a radius of curvature between 16.05 mm and 16.25 mm.

3. The shuttle of claim 1, wherein each of the upper concavities and the lower concavities has a radius of curvature that corresponds to a curvature of a vial.

4. The shuttle of claim 1, wherein the semi-cylindrical upper cavity and the semi-cylindrical lower cavity collectively define a combined cylindrical cavity for receiving a cylindrical data collector.

5. The shuttle of claim 1, further comprising silicone surrounding the cylindrical cavity.

6. The shuttle of claim 1, wherein the upper housing defines a lateral channel.

7. The shuttle of claim 1, wherein the lower housing defines a lateral channel.

8. The shuttle of claim 1, wherein the upper housing and the lower housing collectively define a lateral channel.

9. The shuttle of claim 8, further comprising a perpendicular channel in communication with the lateral channel, the perpendicular channel extending through the upper housing.

10. The shuttle of claim 1, wherein the upper housing defines an inner chamfer, and the lower housing defines an inner rib couplable to the inner chamfer.

11. The shuttle of claim 1, wherein the insulating porous structure defines a number of regularly-arranged interior cells.

12. The shuttle of claim 11, wherein the interior cells are honeycomb-shaped.

13. The shuttle of claim 11, wherein the lower housing and the upper housing comprise polylactic acid.

14. The shuttle of claim 1, further comprising a groove disposed on at least the top surface of the upper housing and the bottom surface of the lower housing.

15. A system comprising:
a shuttle including an upper housing having a top surface, a thickness and a semi-cylindrical upper cavity, the upper housing having a perimeter that includes a plurality of upper concavities, and a lower housing releasably couplable to the upper housing and having a bottom surface, a thickness and a semi-cylindrical lower cavity, the lower housing having a perimeter that includes a plurality of lower concavities configured to be aligned with the plurality of upper concavities the lower housing and the upper housing comprising an insulating porous structure; and
a data collector disposed within the shuttle, the data collector having a main unit and a sensor wire.

16. The system of claim 15, wherein the insulating porous structure defines a number of regularly-arranged interior cells.

17. The system of claim 15, wherein the semi-cylindrical upper cavity and the semi-cylindrical lower cavity collectively define a combined cylindrical cavity for receiving the data collector.

18. The system of claim 17, further comprising silicone surrounding the cylindrical cavity.

19. The system of claim 15, wherein the upper housing and the lower housing collectively define a lateral channel, and a perpendicular channel in communication with the lateral channel, the perpendicular channel extending through the upper housing.

20. The system of claim 19, wherein the sensor wire extends through the perpendicular channel.
